(19) United States
(12) Patent Application Publication
(10) Pub. No.: US 2006/0204937 A1
(43) Pub. Date: Sep. 14, 2006

(54) Method for emotional learning and well-being

(76) Inventor: Josie Grignon, Westlake, OH (US)

Correspondence Address: ROETZEL AND ANDRESS, 222 SOUTH MAIN STREET, AKRON, OH, 44308, US

(21) Appl. No.: 11/365,562

(22) Filed: Mar. 1, 2006

Related U.S. Application Data
(60) Provisional application No. 60/661,394, filed on Mar. 1, 2005.

(51) Int. Cl. G09B 19/00

(52) U.S. Cl. 434/236

(57) ABSTRACT

The present invention generally relates to methods for emotional learning using conditioning.

This application claims priority to U.S. Provisional Application Ser. No. 60/661,394 filed on Mar. 1, 2005 and presently pending.

### BACKGROUND

The present invention relates to a method of learning involving conditioning. Feelings may be described as an emotional awareness or consciousness, and are an integral part of the human experience. Furthermore, healthy expression of feelings positively affects physical and emotional well being. Persons who learn to recognize and identify their feelings are relatively better equipped to understand themselves and relate to others. Such suitably equipped persons are able to identify and voice their emotions effectively, and to behave in socially acceptable ways. Accordingly, there is a need for a method(s) for teaching persons, such as children, to respond to stimuli in desirable ways. The present invention accomplishes this, among other things, through an inventive process of conditioning.

### SUMMARY

The present invention generally relates to a method for emotional learning that involves a process of conditioning. More particularly, the present invention relates to changing or replacing an unconditioned, i.e. base-level, emotional response to a stimulus with a conditioned response. Furthermore, the present invention relates to a process for eliciting the conditioned response.

In one embodiment, the invention includes a method for emotional learning, comprising a teacher selecting a stimulus for conditioning, wherein the stimulus is associated with a negative emotional response; the teacher presenting a student with the selected stimulus; the student experiencing the emotional response that results from presentation with the stimulus; the teacher instructing the student to identify the emotional response; the student identifying the emotional response; the student informing the teacher of the emotional response; the teacher determining whether the emotional response is desirable, undesirable, or neutral; the teacher selecting an emotional expression according to the emotion that he intends to associate with the selected stimulus; the teacher instructing the student to execute the emotional expression; the student executing the emotional expression, wherein the execution contributes to forming an association between the selected stimulus and the emotional expression; and the teacher determining whether the association is sufficiently strong, wherein the teacher ends the process when he determines that the association is sufficiently strong, and wherein the teacher repeats the process when he determines that the association is not sufficiently strong.

### BRIEF DESCRIPTION OF THE DRAWING

FIG. 1 is a flow chart showing three embodiments of phase one (1) conditioning;

FIG. 2 is a flow chart showing several embodiments of phase two (2) use of the conditioned emotional response obtained in phase one (1).

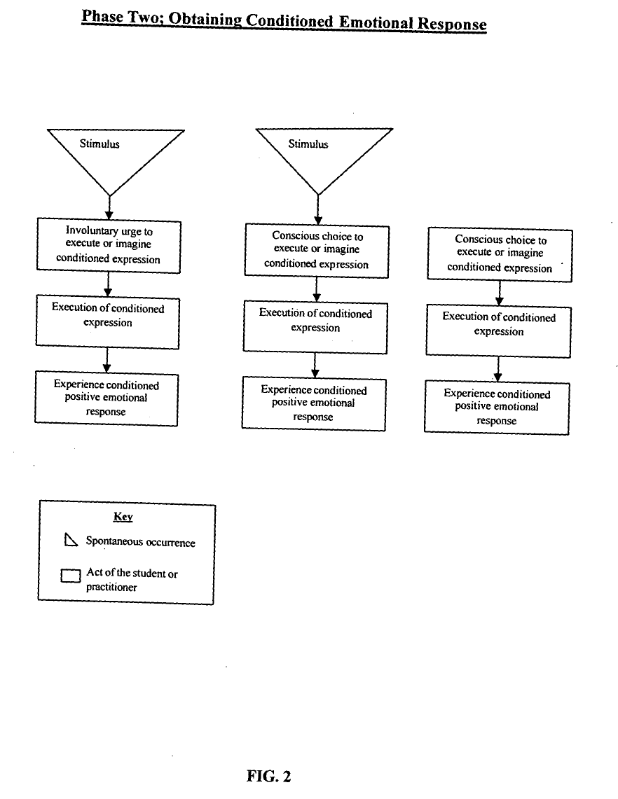

### DETAILED DESCRIPTION

The present invention relates to a method by which a person, such as a child, modifies his emotional state. In accordance with the present invention, a practitioner or a student conditions his mind according to an inventive process thereby forming associations that can be used to modify emotional state(s).

While not being bound by a particular age range or maturity level, the term child, as used herein, generally indicates a person of either gender having an age range of from about 2 years old to about 14 years old. When referring to a young child, the younger portion of the age range, from about 2 years old to about 8 years is generally intended. The term person, as used herein generally means any person including children. The term student includes any person, regardless of age or experience level, that accepts direction from a teacher. The term teacher includes any person, regardless of age or experience level, that administers direction to one or more students. As used herein, the term practitioner includes any person that practices the method of the present invention substantially independently, and generally without the aid of a teacher. As used herein, gender-specific pronouns such as he/she, his/hers, or him/her also include the opposite gender.

Terms of approximation, as used herein, can be applied to modify any quantitative representation that could permissibly vary without resulting in a change in the basic function to which it relates. Accordingly, a value modified by a term or terms, such as “about” and “substantially”, are not limited to the precise value specified.

The term modify, as used herein, includes an act defined by one or more of changing, controlling, altering, attenuating, transforming, or making different. In one embodiment, the term modify includes adjusting the intensity of a emotional state without affecting its nature. In another embodiment, the term modify includes transforming a emotional state from a first type, such as anger, to a second type, such as calm, so that the nature of the emotional state changes. Naturally, the term modify also includes, a change in both the intensity and nature of an emotional state.

As used herein, the term mental imagery includes using ones mind to imagine and/or visualize the performance of physical acts by one's self or by another. Imagery can be carried out by practitioners, students, and/or teachers as defined herein. Furthermore, mental imagery can be carried out with the assistance of a teacher, who guides a student by describing the imagery that the student should imagine. As used herein, the term mental journey is a synonym for the term mental imagery.

As used herein, the term stimulus (stimuli) includes anything that elicits an emotional response, or can be caused to elicit an emotional response. Stimuli within the scope of the present invention include, without limitation, situations causing stress, fright, phobic fright, anger, jealousy, irritation, frustration, and the like. Additionally, stimuli within the scope of the present invention include, without limitation, positive stimuli, which elicit sensations of happiness, love, tranquility, and the like. Finally, stimuli within the scope of the present invention can elicit no emotional response, or a weak emotional response that can be replaced with conditioning. Both mental and physical techniques can be used as stimuli, separately or in combination, to elicit an emotional response.

As used herein, the term emotional response includes sensations that naturally result from experiencing a stimulus, or that are conditioned to result from such stimulus. For instance, if a person experiences an insulting remark, it is natural to feel offended. Thus, in this case the emotional response is the feeling of offence. Notably, different individuals can experience different emotional responses to the same stimulus. Accordingly, no one response is correct or incorrect. Rather, emotional responses can be classified as one or more of (1) expected, positive, and desirable, or as one or more of (2) unexpected, negative, or undesirable. Examples of positive and/or desirable emotional responses include, without limitation, happiness, jubilation, amusement, joy, and the like. Examples of negative and/or undesirable emotional responses include, without limitation, sadness, anger, jealousy, irritation, frustration, anxiety and the like.

As used herein, the term emotional expression includes any physical or mental manifestation of an emotional response. According to the present invention, emotional expressions can be consciously chosen, or unconsciously chosen through conditioning and/or habit formation. Thus, such expressions need not be natural consequences of any given emotional response. For example, a person experiencing an emotional response comprising anger can choose to engage in an activity that remediates the anger, such as drawing. Alternatively, the person can be compelled to draw through conditioning. Thus, in this instance drawing is an emotional expression. Accordingly, emotional expressions within the scope of the present invention include, without limitation, acts such as drawing, dance, sculpture, painting, writing, story telling, discussion and the like. Other emotional expressions can include, without limitation, physical acts such as yoga, tai chi, qi gong, karate, weight training, aerobics or any of a wide variety of physical exercises. Emotional expressions within the scope of the present invention can also include mental acts such as meditation, imagery, prayer, or logic. Emotional expressions can also be natural consequences of an emotional response. For instance, frowning is a natural consequence of an emotional response comprising sadness. Thus, emotional expressions within the scope of the present invention also include frowning, smiling, blushing, and the like, as well as physiological effects that accompany the same. Furthermore, emotional expressions within the scope of the present invention can be acts that are not inherently associated with any emotion, or are associated with emotions that are not desired or not useful. For instance, such expressions can include a clenched fist, a yoga pose, a tia chi movement, or the like.

In one embodiment, the emotional expression has a mood-altering effect. For instance, some individuals find artistic acts soothing. Thus, when such an individual experiences an undesirable emotional response such as anger, he can choose to engage in, or be conditioned to engage in, a form of emotional expression that he finds soothing, such as painting. Accordingly, the undesirable emotional response is transformed into a desirable emotional response.

In another embodiment, the emotional expression has no inherent or natural effect on emotional state, or it has an effect that is not desired or not useful. In this embodiment, the individual is conditioned to associate a desired emotional response with the emotional expression. For instance, through repetition and practice, a particular yoga pose can be associated with happiness. Thus, the individual can cause a happy emotional state to occur by performing the yoga pose to which the emotion is associated. Alternatively, a clenched fist can be associated with calm. Thus, when the individual becomes agitated he can calm himself by clenching his fist. Similarly, any physical or mental expression can be associated with any emotion, and therefore can be used to elicit such emotion.

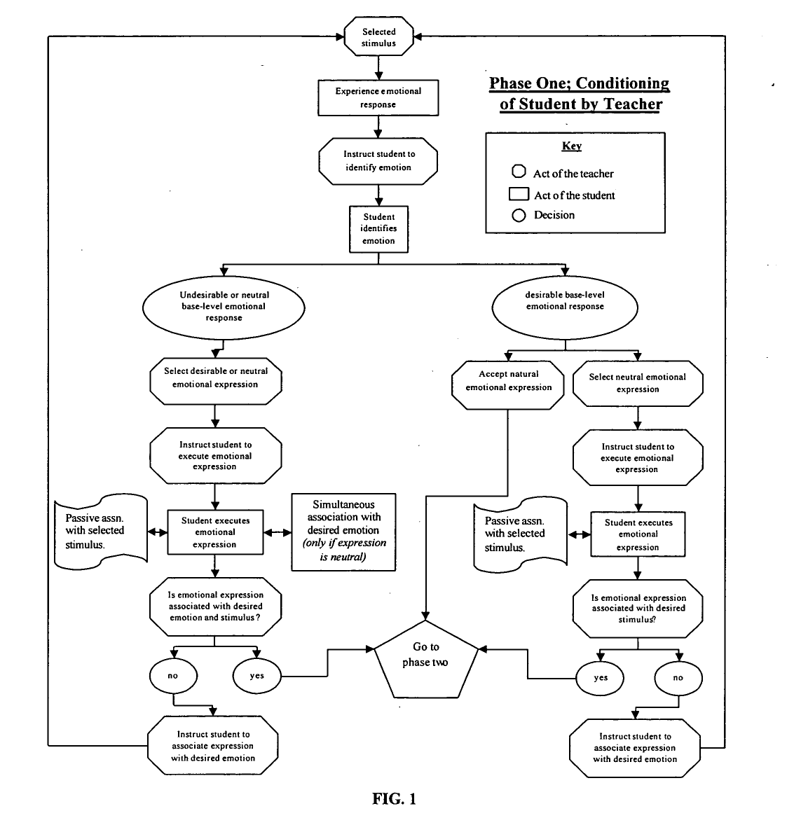

In general, the present invention relates to a process for modifying an emotional state of a person. FIG. 1 shows several embodiments directed to conditioning a student to develop an association between a stimulus, a desired emotional response, and a desired emotional expression. Each embodiment begins with the teacher presenting the student with a stimulus, which is selected for one of three purposes: 1) to change or replace the emotional response that the stimulus elicits in the student, 2) to create an emotional response where previously there was none, or substantially none, or 3) to harness a positive emotional response so that the student can elicit it at will, or upon command. Next, having experienced the stimulus, a base-level emotional response is elicited in the student. The base-level emotional response is that which occurs in the absence of conditioning. The teacher now instructs the student to identify the base-level emotional response, i.e. anger, envy, etc. Optionally, identification can be facilitated by expressing the emotional response. Thus, the teacher can also instruct the student to express the emotion however he feels compelled. The teacher should also ask the student how the stimulus has made him feel. At this point, the teacher decides whether to classify the base-level emotional response as desirable, neutral or undesirable. From this point, the embodiments shown in FIG. 1 differ.

Where the emotional response is undesirable, the teacher selects a desirable emotional expression, which will be used to change or replace the student's base-level emotional response (FIG. 1). In general, a desirable emotional expression is one that is already associated with a desirable emotional response, such that executing the emotional expression generally results in experiencing the associated emotional response. The teacher now instructs the student to execute the desirable emotional expression. At this point three things happen substantially simultaneously: 1) the desirable emotional expression occurs, 2) the associated positive/desirable emotional response is experienced by the student, and 3) the student associates 1 and 2 with the stimulus. The later is a passive association rather than a conscious choice, and occurs because all three items occur in close temporal proximity. At this point, the teacher must assess whether the student has associated all three items strongly enough to move on to the second phase of the process. If the answer is yes, then the teacher can move on to phase two. But, if the answer is no, then the teacher repeats the phase one conditioning process. In most cases, numerous repetitions are required before the student is ready to move on the second phase. The teacher can establish the student's readiness by occasionally testing his response to the stimulus. When the stimulus produces the desired kind and degree of emotional response the association is sufficiently strong, and the student is ready for phase two.

In a closely related embodiment to that of the previous paragraph, the emotional expression is neutral rather than desirable. In this embodiment, the process is essentially the same as that of the previous embodiment except that the teacher must also instruct the student to associate a desirable emotional response with the otherwise neutral emotional expression. In the prior embodiment this was not necessary because the selected emotional expression already had a positive/desirable emotional response associated with it. In contrast, in the present embodiment, the selected emotional expression is neutral, or substantially neutral. Thus, an emotional response must be associated with it.

In a third embodiment set forth in FIG. 1, the base-level emotional response is desirable rather than undesirable. In this embodiment, the teacher selects a neutral emotional expression, and instructs the student to execute the same. When the student does so two things happen substantially simultaneously: 1) the neutral emotional expression occurs, and 2) the emotional expression is associated with the stimulus. Similar to the previous embodiments, this association is passive and occurs because the expression occurs in close temporal proximity to the stimulus. At this point, the teacher must assess whether the student has associated these two items strongly enough to move on to the second phase of the process. If the answer is yes, then the teacher can move on to phase two. But, if the answer is no, then the teacher repeats the phase one conditioning process. Again, in most cases numerous repetitions are required before the student is ready to move on the second phase. The teacher can establish the student's readiness by occasionally testing his response to the stimulus. When the stimulus produces the desired kind and degree of emotional response the association is sufficiently strong and the student is ready for phase two.

In a fourth embodiment set forth in FIG. 1, the base-level emotional response is again desirable, and results in a desirable emotional expression. In this embodiment, the teacher accepts the natural emotional expression and continues to phase 2. The reasoning here is that since the stimulus is already associated with a desirable emotional response, and a desirable emotional expression, such expression is capable of being used to elicit the associated emotional response. Thus, in cases where the base-level emotional response is also the target response, there is no need for conditioning. Notably, this is a limited special case that by-passes the conditioning steps of the present invention.

An alternative embodiment of the present invention comprises the steps of a teacher providing a stimulus to a student for eliciting an emotional response from the student; the student experiencing the stimulus, wherein the stimulus produces an emotional response; the teacher instructing the student to express the emotional response; the student expressing the emotional response; the teacher instructing the student to identify the emotional response and associate the expression with the stimulus; the student identifying the emotional response and associating the expression with the stimulus; and the student practicing the expression thereby altering the student's emotional state according to the association previously formed.

In a still further embodiment, the process of the present invention is adapted to practice by a single person known as a practitioner. In this embodiment the practitioner serves the roles of both student and teacher. Thus, the practitioner conditions himself according to the present invention. The same embodiments set forth in FIG. 1 can be practiced by a practitioner; however, all process steps are performed by the practitioner rather than a student and teacher.

In phase two of the present invention, the student encounters the stimulus of phase one. The encounter is generally natural and does not involve interaction with a teacher. Rather, the encounter occurs by chance and/or in the course of everyday life. For instance, the student experiences an insulting remark. In contrast to phase one, the student is now conditioned to respond differently to the stimulus because his base-level emotional response has been changed or replaced with a conditioned emotional response. Thus, the student's conditioning alters the emotional response that he experiences. In one embodiment, the student experiences the stimulus and feels and unconscious urge or compulsion to execute or imagine the conditioned emotional expression. The student then executes or imagines the conditioned emotional expression. Finally, the student experiences the emotional response associated with the conditioned expression. Thus, the student changes or replaces the base-level response with the conditioned response and controls his emotional state thereby. Notably, the student need not actually perform the emotional expression. In many cases the conditioned emotional response can be obtained by imagining and/or visualizing the conditioned emotional expression.

An alternative embodiment is similar to the previous one except that the student makes a conscious choice to execute or imagine the conditioned emotional expression. In a still further embodiment, the student executes the conditioned emotional expression in the absence of a stimulus. In the latter embodiment, the purpose can be simply to experience the conditioned response rather than to remediate an undesirable base-level response elicited by a stimulus. Similar to the phase one embodiments, all of the embodiments of phase two can be performed by a practitioner, i.e. one who conditioned himself rather than being conditioned by a teacher.

### Examples

The following example coincides with the flowchart in FIG. 1. In this example, the stimulus for which an alternative emotional response is sought comprises parents arguing. In general, children find such a stimulus very unsettling. Therefore, it is useful to have a method for feeling better when such stimulus is encountered. In this example, the teacher directs the student to imagine his mother and father arguing. Thus, this mental imagery comprises the “selected stimulus” set forth in FIG. 1. The student then experiences an emotional response to the selected stimulus, as shown in step two of the flowchart. Initially, the emotional response substantially comprises his natural response to the selected stimulus, which is likely to be negative (e.g. fear, frustration, anxiety etc.).

Next, the teacher instructs the student to identify the emotion that he feels in response to the selected stimulus (step three), and the student does so (step four). At this point the teacher must decide whether the emotional response is positive, negative, or neutral. In this example, we assume that the initial emotional response is negative, so we follow the process from the left branch of the flowchart. Thus, in step six the teacher selects a desirable or neutral emotional expression, i.e. an emotional expression that is naturally associated with a desirable emotional response, or no appreciable emotional response (i.e. the neutral case). For instance, in this example the teacher selects drawing in step six.

Thus, in step seven the teacher directs the student to draw a picture demonstrating how he feels, and the student does so in step eight. In most cases, this type of emotional expression is likely to be naturally associated with a soothing, and therefore positive, emotional response. Thus, in step eight the student associates the selected stimulus, the selected desirable emotional expression, and the desirable emotional response naturally associated therewith.

At this point, the teacher decides whether the foregoing association is sufficiently strong to warrant ending the conditioning process. Of course, the strength of the association increases as the conditioning process is repeated. Accordingly, if the teacher decides that the association is not strong enough, then he repeats the process. Alternatively, if the teacher decides that the association is sufficiently strong, then the conditioning process can be ended, and the student can enter phase two.

In phase two, when the student encounters the stimulus naturally he feels an involuntary, subconscious or unconscious urge to engage in the conditioned emotional expression. In this example, the stimulus is mom and dad arguing. Thus, when the student encounters mom and dad arguing, he feels an involuntary urge to draw. When the student acts on the urge by drawing, he then experiences the positive conditioned emotional response, e.g. the soothing effect of drawing.

Alternatively, when the student encounters the stimulus he can make a conscious choice to engage in the conditioned emotional expression. Engaging in the conditioned emotional expression in this way, has the same effect as engaging in it in response to an unconscious urge. Thus, the student experiences the positive conditioned emotional response, e.g. the soothing effect of drawing.

In a still further example of phase two, the student can make a conscious choice to engage in the conditioned emotional expression even in the absence of the stimulus. In this example, the student need not actually encounter mom and dad arguing. If he wishes to invoke the positive emotional response, he can choose to engage in the conditioned emotional expression. This is particularly useful because the negative emotions associated with the stimulus can affect the student at any time. For instance, the student might recall mom and dad arguing and feel anxiety as a result. Accordingly, he can choose to engage in drawing to alleviate the anxiety. Furthermore, the student may simply wish to elicit the soothing effect of drawing even when he is not particularly anxious.

The present invention is not limited to the examples and embodiments set forth herein. Rather, such embodiments and examples are only illustrative and not limiting. The claims alone define the scope of the present invention. Furthermore, the present invention also includes variations that are readily apparent to one of skill in the art.

I claim:

1. A method for emotional learning, comprising:
a teacher selecting a stimulus for conditioning, wherein the stimulus is associated with a negative emotional response;
the teacher presenting a student with the selected stimulus;
the student experiencing the emotional response that results from presentation with the stimulus;
the teacher instructing the student to identify the emotional response;
the student identifying the emotional response;
the student informing the teacher of the emotional response;
the teacher determining whether the emotional response is desirable, undesirable, or neutral;
the teacher selecting an emotional expression according to the emotion that he intends to associate with the selected stimulus;
the teacher instructing the student to execute the emotional expression;
the student executing the emotional expression, wherein the execution contributes to forming an -association between the selected stimulus, the emotional expression, and a positive emotional response; and
the teacher determining whether the association is sufficiently strong, wherein the teacher ends the process when he determines that the association is sufficiently strong, and wherein the teacher repeats the process when he determines that the association is not sufficiently strong.

2. The method of claim 1, wherein the selected emotional expression is associated with an emotional response selected from positive and neutral.

3. The method of claim 2, wherein when the selected emotional expression is associated with a neutral emotional response, the step of the student executing the selected emotional expression also includes the student associating a positive emotion with the selected emotional expression.
